(19) United States
(12) Patent Application Publication
(10) Pub. No.: US 2013/0043754 A1
(43) Pub. Date: Feb. 21, 2013

(54) ROTOR AND ROTARY ELECTRIC MACHINE CONTAINING THE SAME

(71) Applicants: Hong-Liu Zhu, Shanghai (CN); Jian-Ping Ying, Shanghai (CN); Shi-Xiang Zhang, Shanghai (CN)

(72) Inventors: Hong-Liu Zhu, Shanghai (CN); Jian-Ping Ying, Shanghai (CN); Shi-Xiang Zhang, Shanghai (CN)

(73) Assignee: DELTA ELECTRONICS (SHANGHAI) CO., LTD., Shanghai (CN)

(21) Appl. No.: 13/306,749

(22) Filed: Nov. 29, 2011

(30) Foreign Application Priority Data
Aug. 19, 2011 (CN) 201110240463.1

(51) Int. Cl. H02K 1/27

(52) U.S. Cl. 310/156.07

(57) ABSTRACT

A rotor and a rotary electric machine containing the rotor are provided. The rotor includes a shaft, a rotor core coaxially connected to the shaft, at least one tangential magnetic steel, a first axial magnetic steel, and a second axial magnetic steel. The tangential magnetic steel is fixed in the rotor core along a tangential direction of the rotor core, and has first and second magnetic poles. The first axial magnetic steel disposed at one end surface of the rotor core is adjacent to the first pole, and has a third pole facing the rotor core, wherein the third pole and first pole repel each other. The second axial magnetic steel disposed at the end surface of the rotor core is adjacent to the second pole, and has a fourth pole facing the rotor core, wherein the fourth pole and the second pole repel each other.

### RELATED APPLICATIONS

This application claims priority to Chinese Application Serial Number 201110240463.1, filed Aug. 19, 2011, which is herein incorporated by reference in its entirety.

### BACKGROUND

1. Field of Invention

The invention relates to a rotary electric machine. More particularly, the invention relates to a rotary electric machine with a structure design of magnetic steel.

2. Description of Related Art

A preferred material for forming a magnetic steel of an electric machine is neodymium iron boron. However, currently, the price of rare earth materials is rising; and therefore in order to reduce the cost, it is expected in this industry to use permanent magnetic materials (such as ferrites) with weak magnetic properties but low price to replace the neodymium iron boron. However, since the remanence of the ferrite material is only 0.2-0.44 T, and the maximum magnetic energy product thereof is only 6.4-40 kJ/m³, a simple replacement may cause decrease in output power and efficiency of the electric machine.

Thus, in the prior art, a method in which the axial length of a rotor is increased (i.e., tangential magnetic steel in a rotor core is increased) is used for increasing the sectional area of the magnetic steel and improving the output power. However, this method results in the volume and cost increase of the electric machine. A composite rotor magnetic path structure is also used in the prior art. That is, magnetic steels are arranged along both the tangential and the axial directions in the rotor. However, this structure can only use a space within the rotor diameter to place the magnetic steels, and thus the space for receiving the magnetic steels limited.

In view of this, it is a problem desired to be solved by those of relevant skills in this industry regarding how to design an electric machine, in which the air gap flux density is improved, and hence the output power of the electric machine is improved without increasing the total volume thereof.

### SUMMARY

In order to solve the technical issues mentioned above, an aspect of the invention is to provide a rotor including a shaft, a rotor core coaxially connected to the shaft, at least one tangential magnetic steel fixed in the rotor core along at least one tangential direction of the rotor core, a first axial magnetic steel and a second axial magnetic steel. The tangential magnetic steel has a first and a second magnetic pole. The first axial magnetic steel is disposed at one end surface of the rotor core and adjacent to the first magnetic pole of the tangential magnetic steel. The first axial magnetic steel has a third magnetic pole facing the rotor core, and the third magnetic pole and the first magnetic pole repel each other. The second axial magnetic steel is disposed at an end surface of the rotor core and adjacent to the second magnetic pole of the tangential magnetic steel. The second axial magnetic steel has a fourth magnetic pole facing the rotor core, and the fourth magnetic pole and the second magnetic pole repel each other.

Preferably, the rotor further includes a radial magnetic steel fixed in the rotor core along a direction parallel to the shaft, wherein the radial magnetic steel is adjacent to the tangential magnetic steel.

Another aspect of the invention is to provide a rotary electric machine including an electric machine stator and a rotor. The electric machine stator is formed from stator windings and a stator core, and the rotor is formed from a rotor core and a shaft, and an air gap is provided between the electric machine stator and the rotor. The rotor further includes a plurality of axial magnetic steels respectively disposed at two end surfaces of the rotor core, and a plurality of tangential magnetic steels fixed in the rotor core along tangential directions of the rotor core. Magnetic field lines of the axial magnetic steel and the tangential magnetic steel pass through the air gap.

Preferably, a magnetizing direction of the axial magnetic steel is parallel to the shaft, and magnetizing directions of two adjacent axial magnetic steels are opposite.

Preferably, the material forming the tangential magnetic steel or the axial magnetic steel is ferrite or neodymium iron boron.

Preferably, the rotor further includes a rotor bushing installed on the shaft, for fixing the axial magnetic steel on the end surface of the rotor core, wherein the rotor bushing is made of a permeable material for allowing magnetic field lines of the axial magnetic steel to pass through.

Preferably, the rotor further includes a plurality of radial magnetic steels fixed in the rotor core along a direction parallel to the shaft, wherein one radial magnetic steel is adjacent to two tangential magnetic steels.

Yet another aspect of the invention is to provide a rotor including a shaft, a rotor core coaxially connected to the shaft, a first axial magnetic steel, a second axial magnetic steel and at least one magnetic isolation groove. The first axial magnetic steel disposed at one end surface of the rotor core has a first magnetic pole facing the rotor core. The second axial magnetic steel disposed at the end surface of the rotor core has a second magnetic pole facing the rotor core. The magnetic isolation groove formed in the rotor core along the tangent is positioned between the first and the second axial magnetic steel.

Preferably, the rotor further includes a radial magnetic steel fixed in the rotor core along a direction parallel to the shaft. The radial magnetic steel has a third magnetic pole and a fourth magnetic pole. The fourth magnetic pole is disposed farther away from the shaft than the third magnetic pole, and the fourth magnetic pole and the first or the second magnetic pole repel each other.

Still another aspect of the invention is to provide a rotary electric machine including an electric machine stator and a rotor. The electric machine stator is formed from stator windings and a stator core, and the rotor is formed from a rotor core and a shaft, and an air gap is provided between the electric machine stator and the rotor. The rotor further includes a plurality of axial magnetic steels respectively disposed at two end surfaces of the rotor core; a plurality of radial magnetic steels fixed in the rotor core along a direction parallel to the shaft; and a plurality of magnetic isolation grooves formed in the rotor core along tangential directions of the rotor core for blocking magnetic field lines of the axial magnetic steel from passing through, wherein the magnetic field lines of the axial magnetic steel and the radial magnetic steel pass through the air gap.

Preferably, one or more of the plurality of magnetic isolation grooves are replaced by one or more tangential magnetic steel, so that the magnetic isolation groove and the tangential magnetic steel are mixed and arranged in the rotor core.

Preferably, a magnetizing direction of the axial magnetic steel is parallel to the shaft, and magnetizing directions of two adjacent axial magnetic steels are opposite to each other.

Preferably, the material forming the radial magnetic steel or the axial magnetic steel is ferrite or neodymium iron boron.

Preferably, the rotor further includes a rotor bushing installed on the shaft for fixing the axial magnetic steel on the end surface of the rotor core, wherein the rotor bushing is made of a permeable material for allowing the magnetic field lines of the axial magnetic steel to pass through.

To sum up, in the rotary electric machine provided by the invention, axial magnetic steels are installed at two ends of the rotor core, thereby improving the air gap flux density and hence the output power of the electric machine without increasing the original volume of the electric machine.

### BRIEF DESCRIPTION OF THE DRAWINGS

In order to make the foregoing as well as other aspects, features, advantages, and embodiments of the invention more apparent, the accompanying drawings are described as follows:

FIG. 1 illustrates a cross-sectional view of an electric machine in an embodiment of the invention;

FIG. 2 illustrates a cross-sectional view of the rotary electric machine shown in FIG. 1;

FIG. 3 illustrates a schematic perspective view of a magnetic steel in FIG. 1;

FIG. 4 illustrates a schematic magnetic path view of the magnetic steel in FIG. 3;

FIG. 5 illustrates a schematic view of a rotor bushing in FIG. 1;

FIG. 6 illustrates a cross-sectional view of a rotary electric machine in another embodiment of the invention; and

FIG. 7 illustrates a cross-sectional view of a rotary electric machine in a further embodiment of the invention.

### DETAILED DESCRIPTION

The invention will be described in details in the following embodiments with reference to the accompanying drawings, but these embodiments are not intended to limit the scope of the invention. The description of structure operation does not mean to limit its implementation order. Any device with equivalent functions that is produced from a structure formed by recombination of elements shall fall within the scope of the invention. The drawings are only illustrative and are not made according to the original size.

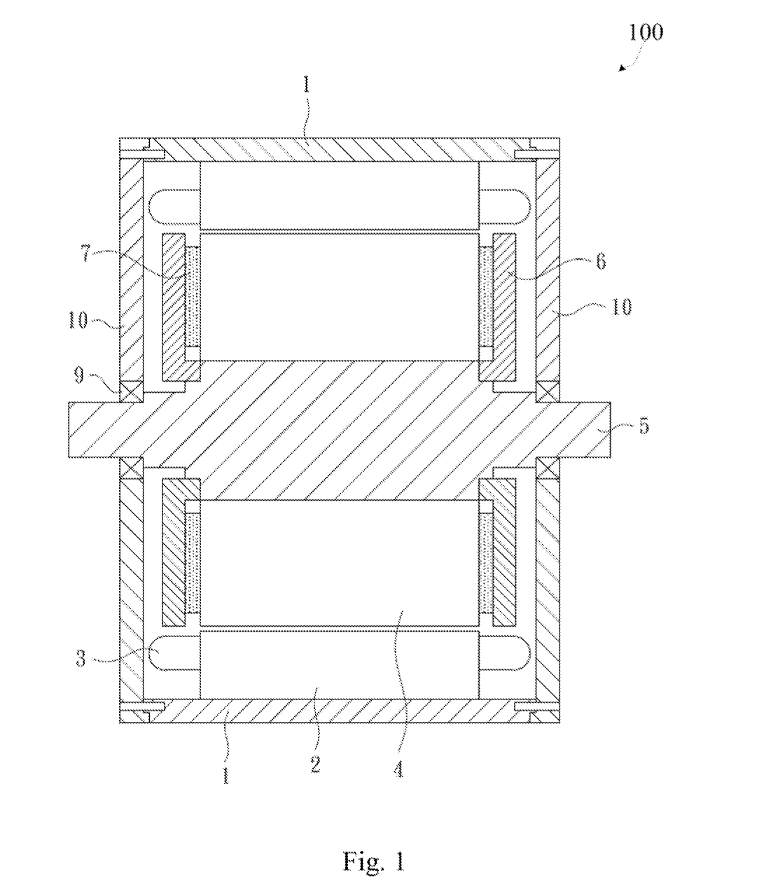

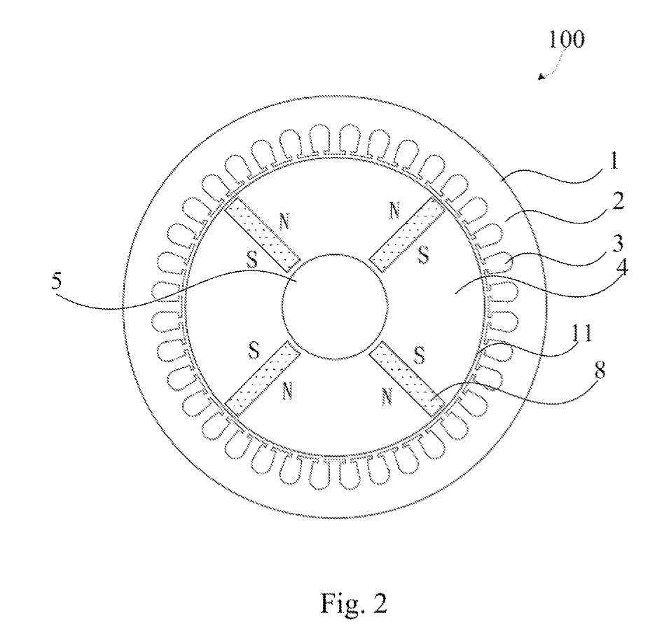

Referring to FIG. 1, FIG. 1 illustrates a cross-sectional view of an electric machine in an embodiment of the invention. As shown in FIG. 1, a rotary electric machine 100 includes a shell 1, a stator core 2, stator windings 3, a rotor core 4, a shaft 5, a rotor bushing 6, an axial magnetic steel 7, a tangential magnetic steel 8 (as shown in FIG. 2), a shaft bearing 9 and an end cover 10. An electric machine stator is formed from the stator core 2 and the stator windings 3. A rotor is formed from the axial magnetic steel 7, the tangential magnetic steel 8, the rotor core 4, the shaft 5, the shaft bearing 9 and the rotor bushing 6 fixed at two ends of the rotor. The electric machine stator and the rotor are installed in the end cover 10 and the shell 1. Moreover, the rotary electric machine 100 provided in the invention is a permanent magnetic electric machine.

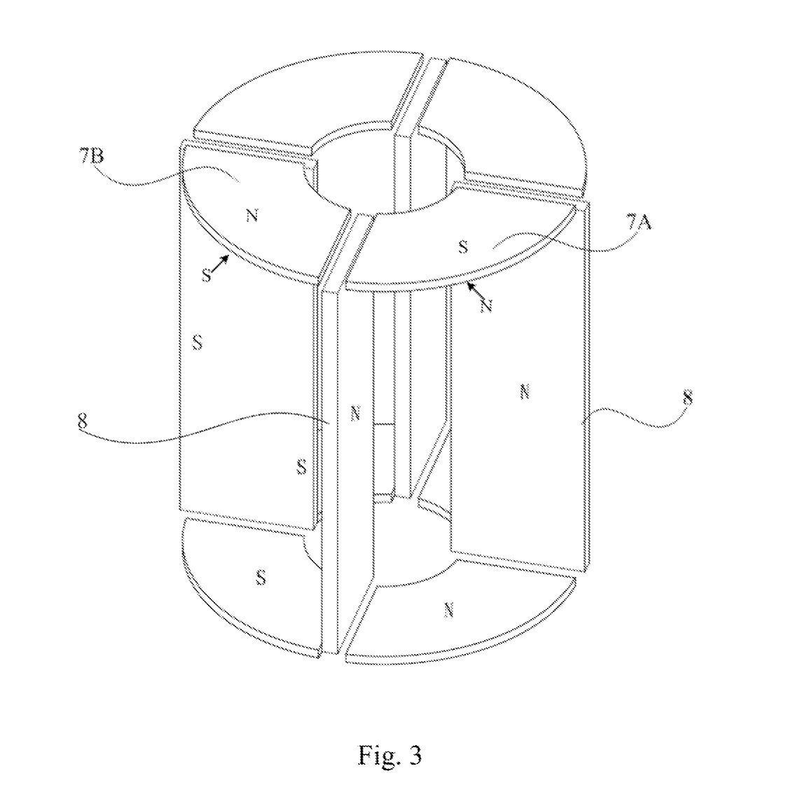

Referring to FIGS. 2 and 3, FIG. 2 illustrates a cross-sectional view of the rotary electric machine in FIG. 1, and FIG. 3 illustrates a schematic perspective view of the magnetic steel in FIG. 1. As shown in FIG. 2, in this embodiment, the tangential magnetic steel 8 is of a 4-pole structure, and each pole includes an S pole and an N pole. However, in other embodiments, for example, the tangential magnetic steel 8 may be of a 6-pole or 8-pole structure, but not limited thereto. Additionally, it is known from FIG. 2 that an air gap 11 is provided between the electric machine stator and the rotor. As shown in FIG. 3, the magnetic steel includes the axial magnetic steel 7 and the tangential magnetic steel 8. The material forming the axial magnetic steel 7 and the tangential magnetic steel 8 is preferably ferrite, and for example, the material may also be neodymium iron boron, but not limited thereto.

The specific structure of the rotary electric machine 100 in this embodiment will be described with reference to FIGS. 1, 2 and 3 hereinafter.

In this embodiment, each tangential magnetic steel 8 is installed in a respective rotor core 4, and each tangential magnetic steel 8 has magnetic poles S and N. The axial magnetic steel 7 is installed at the end surface (in the axial zone) of the rotor core 4 and is adjacent to the tangential magnetic steel 8. The magnetizing direction of the axial magnetic steel 7 is parallel to the shaft 5. The magnetizing directions of two adjacent axial magnetic steels 7 are opposite to comply with a polar parallelism relation. For example, the axial magnetic steel 7A and the axial magnetic steel 7B have opposite polarities. In this embodiment, the axial magnetic steel 8 and the tangential magnetic steel 7 comply with a polar parallelism relation. As shown in FIG. 3, the magnetic pole of the axial magnetic steel 7A at the face adjacent to the rotor core 4 is an N pole, and thus the magnetic pole of the tangential magnetic steel 8 at the face adjacent to the N pole of the axial magnetic steel 7A is an N pole, wherein the two N poles repel with each other, and vice versa, the magnetic pole of the axial magnetic steel 7B at the face adjacent to the rotor core 4 is an S pole, and thus the magnetic pole of the tangential magnetic steel 8 at the face adjacent to the S pole of the axial magnetic steel 7B is an S pole. Other axial magnetic steels 7 and tangential magnetic steels 8 also comply with similar polar relations, and no further description will be stated herein.

It should be noted that the number and installing position of the axial magnetic steels 7 are not limited thereto, as long as the number satisfies the polar parallelism relation, and the installing position is in the axial zone. For example, if the number of the axial magnetic steels 7 is two, the axial magnetic steels 7 may be both installed at one end of the rotor core 4. If the number of the axial magnetic steels 7 is four, the axial magnetic steels 7 may be all installed at one end of the rotor core 4, or every two axial magnetic steels 7 may be installed at each end of the rotor core 4. If the number of the axial magnetic steels 7 is six, four axial magnetic steels 7 may be installed at one end of the rotor core 4, and two axial magnetic steels 7 may be installed at the other end of the rotor core 4. If the number of the axial magnetic steels 7 is eight, every four axial magnetic steels 7 may be installed at each end of the rotor core 4. The foregoing descriptions are merely stated for illustration, wherein the number of the axial magnetic steels 7 may be flexibly determined in accordance with the structure of the tangential magnetic steel 8 and the actual requirements, and the installing position may also be flexibly determined. In this embodiment, preferably, eight axial magnetic steels 7 are taken as an example for explanation, which are installed at two ends of the rotor core 4.

Additionally, the axial magnetic steel 7 is fixed at the end surface of the rotor core 4 through the rotor bushing 6. The rotor bushing 6 is fixed on the shaft 5. The stator formed from the stator core 2 and the stator windings 3 is installed in the shell 1. The shell 1 and the stator core 2 abut against each other, so as to fix the stator core 2. End covers 10 are respectively installed at two ends of the shell 1, and the end covers 10 are installed on the shaft 5 through the shaft bearing 9.

Referring to FIGS. 1 and 3 again, the position arrangement and relationship between the axial magnetic steels 7 and the tangential magnetic steels 8 are illustrated. The axial magnetic steels 7 are installed at the end surface of the rotor core 4, and the magnetizing directions of two adjacent axial magnetic steels 7 are opposite. In other words, the axial magnetic steels 7 at the same end surface are arranged in a magnetically staggered manner, such as the axial magnetic steels 7A and 7B. The tangential magnetic steels 8 are fixed in the rotor core 4 along the tangential directions. Two tangential magnetic steels 8 facing each other magnetically repel with each other, and each tangential magnetic steel 8 is arranged tangential to the position between two axial magnetic steels 7. Moreover, the adjacent axial magnetic steel 7 and tangential magnetic steel 8 magnetically repel with each other. For example, if the magnetic pole of the axial magnetic steel 7A at the face adjacent to the rotor core 4 is an N pole, then the magnetic pole of the adjacent tangential magnetic steel 8 at the face adjacent to the N pole of the axial magnetic steel 7A is also an N pole, wherein the two N poles repel with each other. Similarly, if the magnetic pole of the axial magnetic steel 7B at the face adjacent to the rotor core 4 is an S pole, then the magnetic pole of the adjacent tangential magnetic steel 8 at the face adjacent to the S pole of the axial magnetic steel 7B is also an S pole.

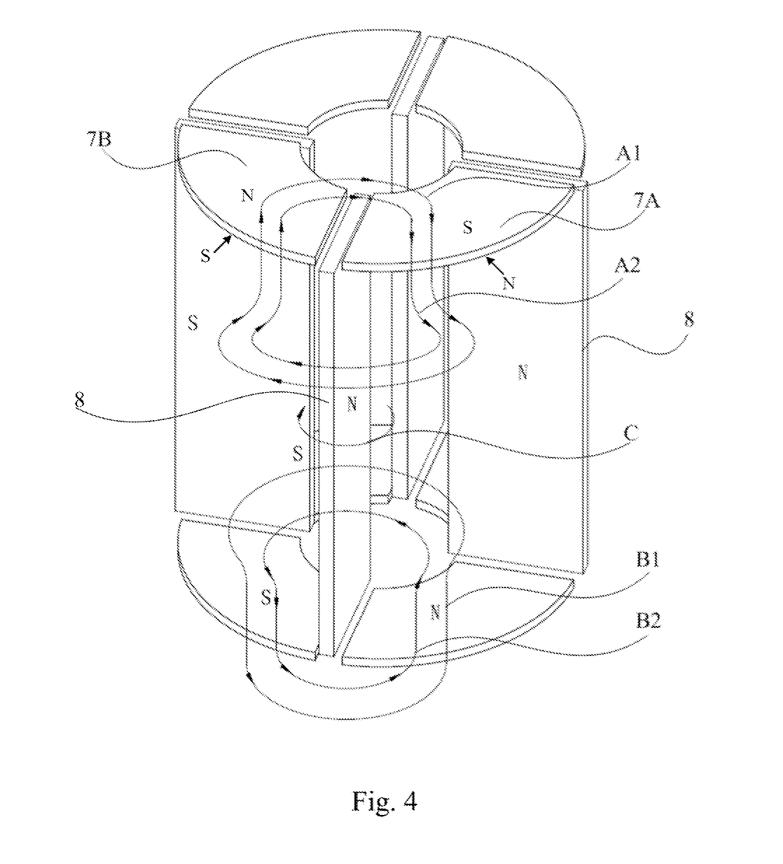

Referring to FIGS. 2 and 4 at the same time, FIG. 4 illustrates a schematic magnetic path view of the magnetic steel in FIGS. 3. The magnetic path of the axial magnetic steel 7 is described in detail below. In this embodiment, adjacent axial magnetic steels 7A and 7B are taken as an example for explanation.

Firstly, the magnetic field line A1 extends from the N pole of the axial magnetic steel 7A (the magnetic pole adjacent to the rotor core 4) into the rotor core 4, and then proceeds in the rotor core 4 along a direction parallel to the shaft 5, and subsequently reaches the stator core 2 after passing through the air gap 11 between the stator and the rotor along the radial direction of the rotor core 4, and then returns to rotor core 4 from the stator core 2 through the air gap 11, and thereafter reaches the S pole of the adjacent axial magnetic steel 7B through the rotor core 4, and finally the magnetic field line A1 extends from the N pole of the adjacent axial magnetic steel 7B and returns to the S pole of the axial magnetic steel 7A through the rotor bushing 6, thereby forming a loop of the magnetic field line A1. The magnetic path of the magnetic field line A2 is similar to that of the magnetic field line A1, and thus no further description will be stated herein. The magnetic field lines B1 and B2 are respectively symmetrical with the magnetic field lines A1 and A2, and no further description will be stated herein. It should be noted that, in this embodiment, the magnetic field lines A1, A2, B1 and B2 of the axial magnetic steel 7 are merely depicted for illustration, and in practice, the axial magnetic steel 7 has countless magnetic field lines.

It should also be pointed out that, due to the presence of the tangential magnetic steel 8, the magnetic field line of the axial magnetic steel 7 is prevented from extending from the N pole of the axial magnetic steel along the rotor core 4 and directly entering the S pole of the adjacent axial magnetic steel without passing through the air gap 11 and the stator core 2. That is, the tangential magnetic steel 8 described herein has a function of magnetic isolation. Particularly, for example, the tangential magnetic steel 8 is provided between the adjacent axial magnetic steel 7A and axial magnetic steel 7B. It can be known from FIG. 4 (with reference to FIG. 1) that the magnetic pole of the axial magnetic steel 7A at the face adjacent to the rotor core 4 is an N pole, and the magnetic pole of the adjacent tangential magnetic steel 8 at the face adjacent to the N pole of the axial magnetic steel 7A is also an N pole, wherein the two N poles repel with each other. Thus, if the magnetic field line of the axial magnetic steel 7A is assumed to extend towards the direction of the tangential magnetic steel 8 after entering the rotor core 4, the magnetic field line would be blocked by the tangential magnetic steel 8, so that the magnetic field line of the axial magnetic steel 7A could not pass through the tangential magnetic steel 8. That is, the tangential magnetic steel 8 here has certain functions of magnetic isolation.

The magnetic field line C of the tangential magnetic steel 8 extends from the N pole of the tangential magnetic steel 8, and reaches the S pole of the tangential magnetic steel 8 through the air gap 11, and subsequently returns to the N pole of the tangential magnetic steel 8 through the inner part of the tangential magnetic steel 8. It should be noted that only one magnetic field line of the tangential magnetic steel 8 is depicted herein for illustration, and in practice, each tangential magnetic steel 8 has countless magnetic field lines similar to the magnetic field line C.

It can be known from the above description that, in this embodiment, the magnetic field lines passing through the air gap 11 not only include the magnetic field lines generated by the tangential magnetic steel 8, but also includes the magnetic field lines generated by the axial magnetic steel 7. That is, in comparison with the electric machine of the prior art, the magnetic field lines in the air gap 11 also include the magnetic field lines generated by the axial magnetic steel 7, and thus the air gap flux density of the electric machine is improved, and hence the output power of the electric machine is improved without increasing the volume of the electric machine or materials of the stator core, stator windings and the rotor core.

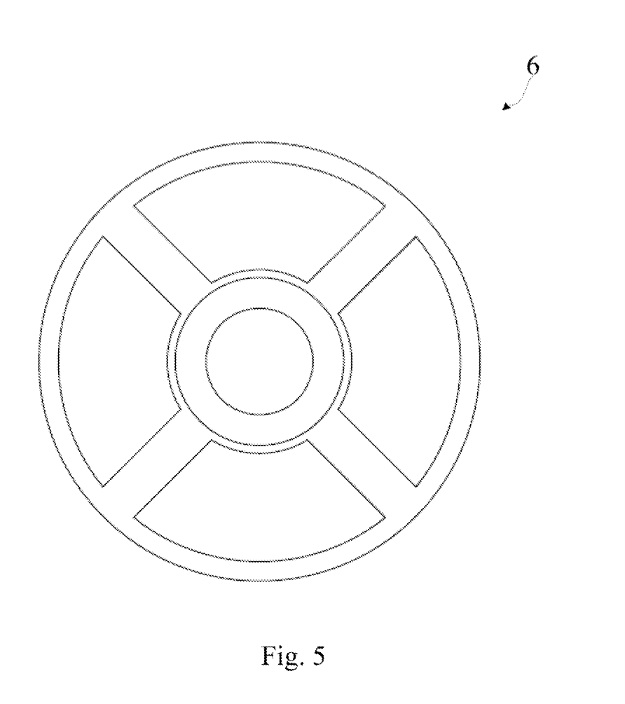

Referring to FIG. 5, FIG. 5 illustrates a schematic view of the rotor bushing in FIG. 1. As shown in FIGS. 1 and 5, the rotor bushing 6 is used for fixing the axial magnetic steel 7 at the end surface of the rotor core 4, and in this embodiment, the rotor bushing 6 is made of a permeable material to allow the magnetic field lines of the axial magnetic steel 7 to pass through (referring to the foregoing descriptions for the details). That is, in this embodiment, the rotor bushing 6 also can be used for assisting to form the magnetic field line loop of the axial magnetic steel 7.

The advantages of this embodiment can be verified through specific experiment data described below. If an electric machine in which the material of the magnetic steel is neodymium iron boron is taken as a reference group, wherein the specification of the electric machine includes “an outer diameter of 270 mm, a axial length of 153 mm, and an air gap length of 0.8 mm”, and the electric machine only has a tangential magnetic steel inserted in the rotor core. If the prior art merely changing the material of the magnetic steel from the neodymium iron boron to ferrite is adopted for the electric machine, the air gap flux density of the electric machine is decreased by 30%. If the electric machine provided by the invention is adopted, which not only has the tangential magnetic steel inserted in the rotor core, but also has axial magnetic steels installed at two ends of the rotor core, when the material of magnetic steel is also assumed to be ferrite, then It can be known from calculation that, when the volume of the ferrite magnetic steel is about 6.1 times as large as that of the neodymium iron boron magnetic steel, the air gap flux density of the electric machine of this embodiment using the ferrite magnetic steel is substantially equal to that of the electric machine using the neodymium iron boron magnetic steel. However, since the material of the magnetic steel used in this embodiment is ferrite with a relative low price, in comparison with the relative expensive material, neodymium iron boron magnetic steel, originally adopted by the reference group, the overall magnetic steel cost is decreased to 28% of the overall magnetic steel cost of the reference group. In comparison with the prior art in which the length of the tangential magnetic steel is increased to provide the air gap flux density (the volume of the electric machine is thus increased), the electric machine of this embodiment does not increase the volume of the electric machine. Furthermore, in comparison with the current composite rotor magnetic path structure, since the magnetic steel of this embodiment is installed at two ends of the rotor core rather than in the rotor core, no limitation will be imposed on the volume of the magnetic steel of this embodiment.

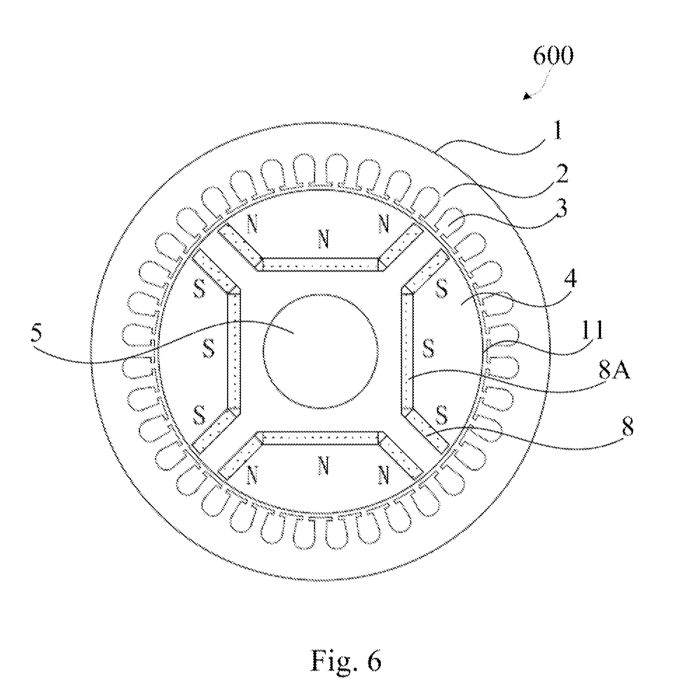

Referring to FIG. 6, FIG. 6 illustrates a cross-sectional view of a rotary electric machine in another embodiment of the invention. As shown in FIG. 6, the difference between a rotary electric machine 600 and the rotary electric machine 100 is that the rotary electric machine 600 adopts a composite structure. That is, in the direction parallel to the shaft 5, the rotary electric machine 600 not only has the tangential magnetic steels 8 inserted in the rotor core 4, but also has radial magnetic steels 8A inserted in the rotor core 4. The radial magnetic steels 8A are fixed in the rotor core 4 along a direction parallel to the shaft 5 and are adjacent to the tangential magnetic steels 8. In this embodiment, the axial magnetic steels (not shown) may also be installed at two ends of the rotor core 4. The specific installing position and structure of the axial magnetic steels can be known with reference to FIGS. 1 and 3, and no further description will be stated herein. The magnetic field lines of the axial magnetic steels are the same as the magnetic field lines shown in FIG. 4 (e.g., A1 and A2). In this embodiment, since axial magnetic steels are added at two ends of the rotor core 4, the air gap flux density is further improved.

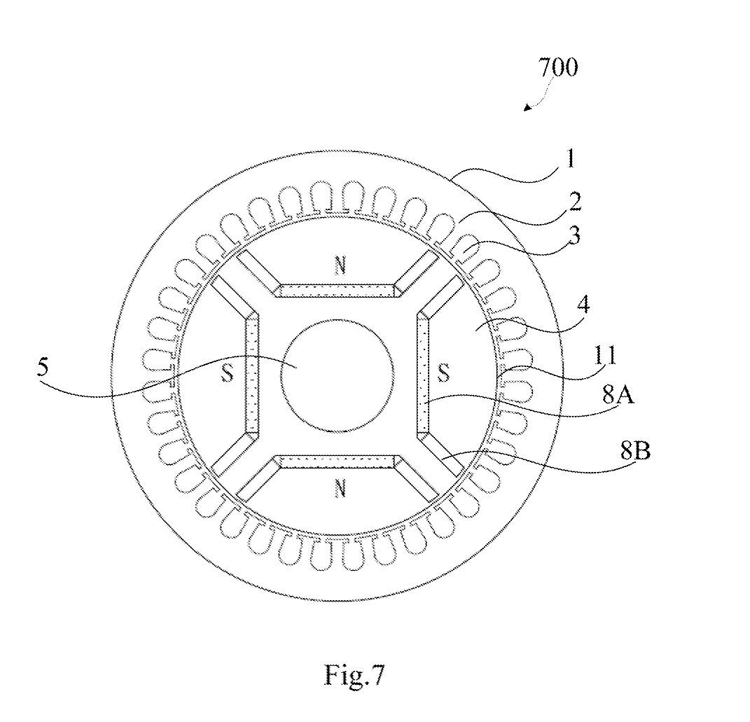

Referring to FIG. 7, FIG. 7 illustrates a cross-sectional view of a rotary electric machine in a further embodiment of the invention. As shown in FIG. 7, the difference between a rotary electric machine 700 and the rotary electric machine 600 is that the rotary electric machine 700 adopts a radial structure. That is, the rotary electric machine 700 has the radial magnetic steels 8A and does not have the tangential magnetic steels.

Particularly, in this embodiment, the rotor includes the radial magnetic steels 8A, magnetic isolation grooves 8B and axial magnetic steels (not shown). Each of the radial magnetic steels 8A is fixed in the rotor core 4 along a direction parallel to the shaft 5, and has magnetic poles S and N. The magnetic isolation grooves 8B are arranged in the rotor core 4 along the tangential directions of the rotor core 4, and are adjacent to the radial magnetic steels 8A. The axial magnetic steels are installed at two end surfaces of the rotor core 4 and specific details can be known with reference to FIGS. 1 and 3. In this embodiment, the radial magnetic steels 8A and the axial magnetic steels have certain polar relations. Particularly, in two magnetic poles of the radial magnetic steel 8A, both the magnetic pole thereof located farther away from the shaft 5 and the magnetic pole of the axial magnetic steel at the face adjacent to the rotor core 4 repel each other. In this embodiment, the magnetic isolation groove 8B is arranged tangential to the position between each two axial magnetic steels. Preferably, the magnetic isolation groove 8B is an air magnetic isolation groove.

In this embodiment, the magnetic field lines of the axial magnetic steels are the same as the magnetic field lines shown in FIG. 4 (e.g., A1 and A2), and thus no further description will be stated herein.

In this embodiment, the magnetic isolation grooves 8B are used for blocking the magnetic field lines of the axial magnetic steels from passing through, thereby preventing the magnetic field lines of the axial magnetic steels from extending from the N poles of the axial magnetic steels along the rotor core 4 and directly entering the S poles of the adjacent axial magnetic steels without passing through the air gap 11 and the stator core 2. In this embodiment, in a similar way, the axial magnetic steels (not shown) may also be installed at two ends of the rotor core 4.

In this embodiment, one or more magnetic isolation grooves 8B may also be replaced by the tangential magnetic steels. That is, the tangential magnetic steel and the magnetic isolation groove 8B are mixed and arranged in the rotor core 4.

In view of the above, in the rotary electric machine provided by the invention, the axial magnetic steels are installed at two ends of the rotor core, thereby improving the air gap flux density and hence the output power of the electric machine without increasing the original volume of the electric machine. The rotary electric machine provided by the invention is suitable for improve the air gap flux density without increasing the volume of the electric machine, and is especially appropriate for applying magnetic steels with low magnetic energy product in the electric machine. As such, the air gap flux density is improved without increasing the volume of the electric machine, and the cost of the electric machine is reduced.

Although the invention has been disclosed with reference to the above embodiments, these embodiments are not intended to limit the invention. It will be apparent to those skilled in the art that various modifications and variations can be made without departing from the spirit and scope of the invention. Therefore, the scope of the invention shall be defined by the appended claims.

What is claimed is:

1. A rotor, comprising:
a shaft;
a rotor core coaxially connected to the shaft;
at least one tangential magnetic steel fixed in the rotor core along at least one tangential direction of the rotor core, wherein the tangential magnetic steel has a first magnetic pole and a second magnetic pole;
a first axial magnetic steel which is disposed at one end surface of the rotor core and is adjacent to the first magnetic pole of the tangential magnetic steel, wherein the first axial magnetic steel has a third magnetic pole facing the rotor core, and the third magnetic pole and the first magnetic pole repel each other; and
a second axial magnetic steel which is disposed at the end surface of the rotor core and is adjacent to the second magnetic pole of the tangential magnetic steel, wherein the second axial magnetic steel has a fourth magnetic pole facing the rotor core, and the fourth magnetic pole and the second magnetic pole repel each other.

2. The rotor of claim 1, wherein the rotor further comprises a radial magnetic steel fixed in the rotor core along a direction parallel to the shaft, wherein the radial magnetic steel is adjacent to the tangential magnetic steel.

3. A rotary electric machine, comprising an electric machine stator formed from a plurality of stator windings and a stator core, and a rotor formed from a rotor core and a shaft, wherein an air gap is provided between the electric machine stator and the rotor, the rotor further comprising:
a plurality of axial magnetic steels respectively disposed at two end surfaces of the rotor core; and
a plurality of tangential magnetic steels fixed in the rotor core along tangential directions of the rotor core,
wherein magnetic field lines of the axial magnetic steel and the tangential magnetic steel pass through the air gap.

4. The rotary electric machine of claim 3, wherein a magnetizing direction of the axial magnetic steel is parallel to the shaft, and magnetizing directions of two adjacent axial magnetic steels are opposite.

5. The rotary electric machine of claim 3, wherein the material forming the tangential magnetic steel or the axial magnetic steel is ferrite or neodymium iron boron.

6. The rotary electric machine of claim 3, wherein the rotor further comprises:
a rotor bushing installed on the shaft for fixing the axial magnetic steel on the end surface of the rotor core, wherein the rotor bushing is made of a permeable material to allow the magnetic field lines of the axial magnetic steels passing through.

7. The rotary electric machine of claim 3, wherein the rotor further comprises:
a plurality of radial magnetic steels fixed in the rotor core along a direction parallel to the shaft, wherein each of the radial magnetic steels is adjacent to two tangential magnetic steels.

8. A rotary electric machine, comprising an electric machine stator formed from a plurality of stator windings and a stator core and a rotor formed from a rotor core and a shaft, wherein an air gap is provided between the electric machine stator and the rotor, the rotor further comprising:
at least one axial magnetic steel respectively disposed at at least one end surface of the rotor core;
at least one radial magnetic steel fixed in the rotor core along a direction parallel to the shaft; and
at least one magnetic isolation groove formed in the rotor core along tangential directions of the rotor core for preventing magnetic field lines of the at least oneaxial magnetic steel from passing through,
wherein magnetic field lines of the at least one axial magnetic steel and the at least one radial magnetic steels pass through the air gap.

9. The rotary electric machine of claim 8, wherein the at least one magnetic isolation groove is replaced by at least one tangential magnetic steel, so that the magnetic isolation groove and the tangential magnetic steel are mixed and arranged in the rotor core.

10. The rotary electric machine of claim 8, wherein the magnetizing direction of the axial magnetic steel is parallel to the shaft, and magnetizing directions of two adjacent axial magnetic steels are opposite.

11. The rotary electric machine of claim 8, wherein the material forming the radial magnetic steel or the axial magnetic steel is ferrite or neodymium iron boron.

12. The rotary electric machine of claim 8, wherein the rotor further comprises:
a rotor bushing installed on the shaft for fixing the axial magnetic steel on the end surface of the rotor core, wherein the rotor bushing is made of a permeable material to allow the magnetic field lines of the axial magnetic steel to pass through.
